(19) United States
(12) Patent Application Publication
(10) Pub. No.: US 2025/0293495 A1
(43) Pub. Date: Sep. 18, 2025

(54) WIRE HARNESS

(71) Applicant: Yazaki Corporation, Tokyo (JP)

(72) Inventors: Ryo NAGASHIMA, Shizuoka (JP); Takashi OOKAWA, Shizuoka (JP)

(73) Assignee: Yazaki Corporation, Tokyo (JP)

(21) Appl. No.: 19/050,416

(22) Filed: Feb. 11, 2025

(30) Foreign Application Priority Data
Mar. 12, 2024 (JP) 2024-038227

(51) Int. Cl. H02G 3/04; B60R 16/02; H01B 7/00

(52) U.S. Cl. CPC H02G 3/0468; H01B 7/0045; B60R 16/0207

(57) ABSTRACT

A wire harness includes a wiring material bundle, an exterior member including an exterior body which extends along an axial direction and of which a cross-sectional shape viewed from the axial direction is formed in an arc shape, and an opening formed to extend from one end to the other end of the exterior body along the axial direction, and a filling member filling at least a part of the inside of the opening in an accommodated state where the wiring material bundle is accommodated in the exterior body.

### CROSS-REFERENCE TO RELATED APPLICATION(S)

The present application claims priority to and incorporates by reference the entire contents of Japanese Patent Application No. 2024-038227 filed in Japan on Mar. 12, 2024.

### BACKGROUND OF THE INVENTION

### 1. Field of the Invention

The present invention relates to a wire harness.

### 2. Description of the Related Art

Conventionally, there is a corrugated tube as an exterior member for protecting a wire harness (see, for example, Japanese Patent Application Laid-open No. 2019-115229). The corrugated tube can be bent, for example, in accordance with the routing path.

Meanwhile, a conventional exterior member is provided with a slit in the axial direction, and it is necessary to wind a tape by housing a wire harness inside from the slit. This tape winding has a difference in operation speed and appearance depending on skill, and thus needs to be improved.

### SUMMARY OF THE INVENTION

An object of the present invention is to provide a wire harness capable of reducing machining work on an exterior member.

A wire harness according to one aspect of the invention includes a wiring material; an exterior member including an exterior body of which a cross-sectional shape viewed from an axial direction is formed in an arc shape and which extends along the axial direction, and an opening formed to extend from one end to an other end of the exterior body along the axial direction; and a filling member that fills at least a part of an inner side of the opening in an accommodated state where the wiring material is accommodated in the exterior body.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic view illustrating a schematic configuration of a wire harness according to an embodiment;

FIG. 2 is a cross-sectional view taken along line A-A in FIG. 1;

FIG. 3 is a schematic view of an exterior body and a filling member in a linear portion of an exterior member;

FIG. 4 is a schematic view of a curved portion of the exterior member;

FIG. 5 is a schematic view of an exterior body and a filling member in a curved portion of an exterior member;

FIG. 6 is a schematic view illustrating a schematic configuration of a wire harness according to a first modification of the embodiment;

FIG. 7 is a schematic view illustrating a schematic configuration of a wire harness according to a second modification of the embodiment;

FIG. 8 is a cross-sectional view taken along line B-B in FIG. 7; and

FIG. 9 is a schematic view illustrating a schematic configuration of a wire harness according to a third modification of the embodiment.

### DETAILED DESCRIPTION OF THE PREFERRED EMBODIMENTS

Hereinafter, an embodiment according to the present invention will be described in detail with reference to the drawings. Note that the present invention is not limited by the following embodiments. That is, components in the following embodiments include those that can be easily assumed by those skilled in the art or those that are substantially the same, and various omissions, substitutions, and changes can be made without departing from the gist of the invention.

In the following description, the X direction in the drawing is referred to as an X direction. The axial direction X corresponds to the extending direction of each of a wiring material W, a wiring material bundle WT, and an exterior member 1.

### Embodiment

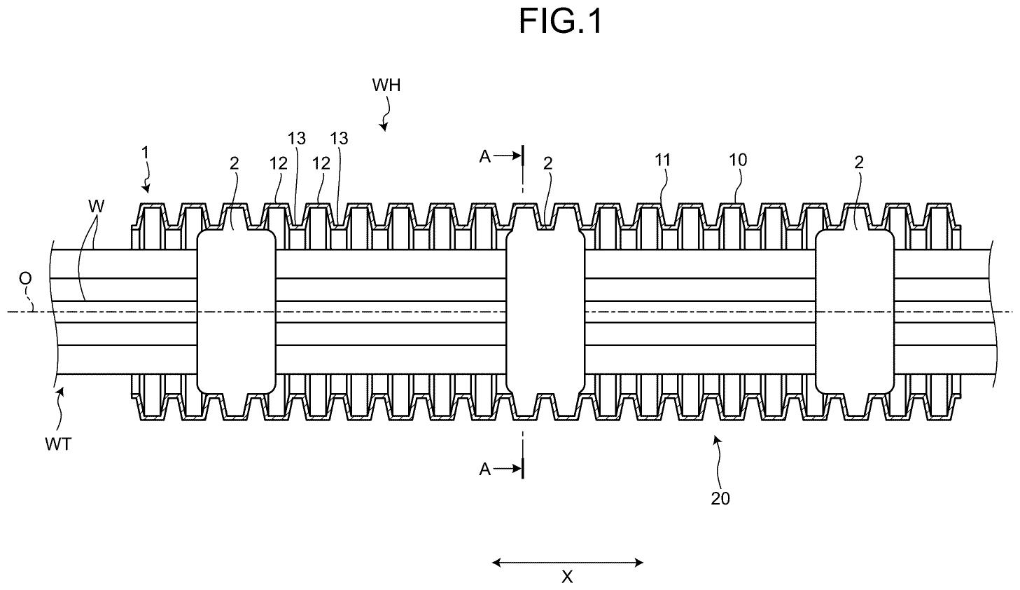

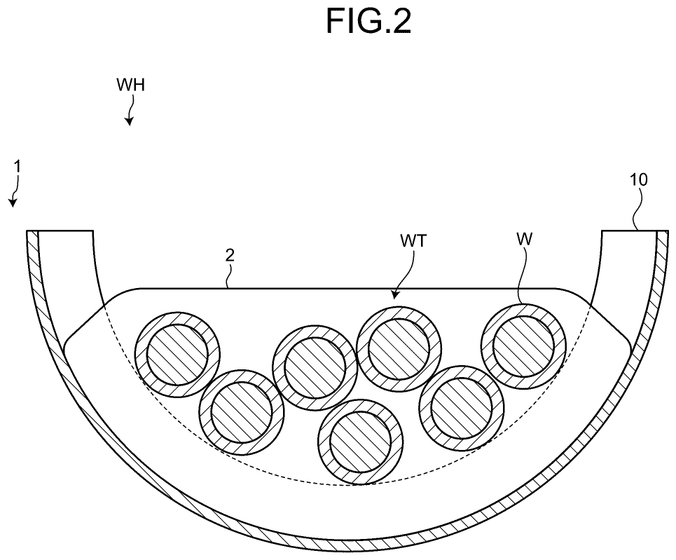

In a wire harness WH in the present embodiment, for example, a plurality of wiring materials W used for power supply and signal communication is used as a wiring material bundle WT to form a collective component, and the plurality of wiring materials W are connected to each device by a connector or the like (not illustrated) for connection between devices mounted on a vehicle. As illustrated in FIGS. 1 and 2, the wire harness WH includes a wiring material bundle WT, an exterior member 1 that accommodates and protects the wiring material bundle WT, and a filling member 2. The wire harness WH may include a grommet, a protector, a fixture, and the like (not illustrated).

The wiring material W is configured to include, for example, a conductive linear core wire and a covering portion having an insulating property that covers the outside of the core wire. The wiring material W is, for example, an insulated electric wire in which a core wire is covered with a covering portion. The core wire is formed by bundling a plurality of strands of a conductive metal, for example, copper, a copper alloy, aluminum, an aluminum alloy, or the like. The core wire may be a stranded core wire obtained by twisting a plurality of strands. The covering portion is an electric wire covering that covers the outer peripheral side of the core wire. The covering portion is formed by extruding, for example, an insulating resin material (PP, PVC, crosslinked PE, or the like. It is appropriately selected in consideration of abrasion resistance, chemical resistance, heat resistance, and the like.) and the like.

The exterior member 1 is, for example, a cylindrical corrugated tube that covers the wiring material bundle WT. Similarly to the corrugated tube, the exterior member 1 is made of an insulating resin material or the like. The exterior member 1 includes an exterior body 10 and an opening 11.

The exterior body 10 extends along the axial direction X, and has an arc-shaped cross-sectional shape as viewed in the axial direction X. The exterior body 10 of the present embodiment has a shape obtained by dividing a cylindrical corrugated tube in half, and a cross-sectional shape viewed from the axial direction X is formed in a semicircular shape.

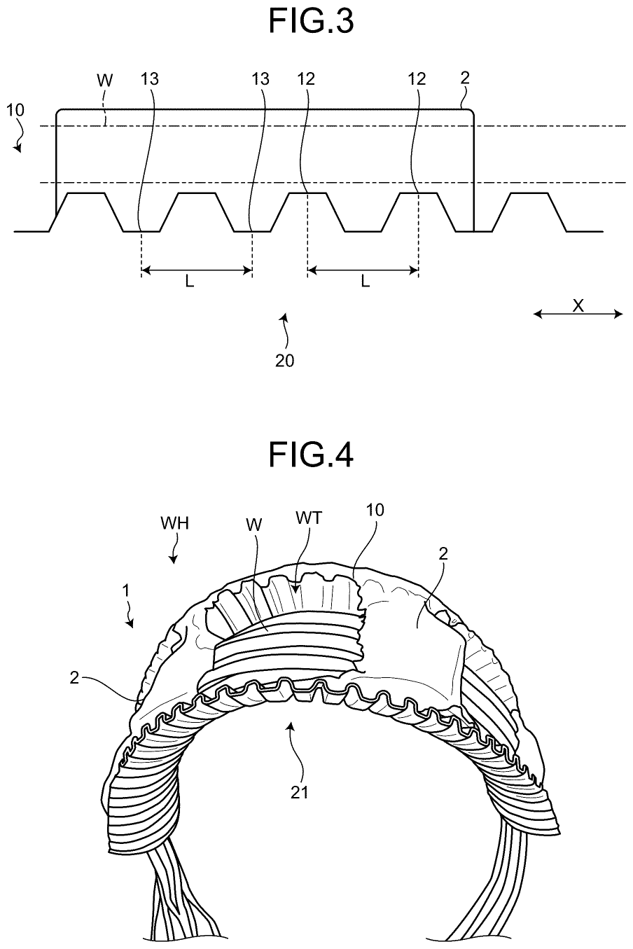

As illustrated in FIG. 1, in the exterior body 10, a plurality of crest portions 12 formed in an arc shape around a central axis O along the axial direction X and protruding toward one side in the radial direction intersecting the axial direction X and a plurality of valley portions 13 formed in an arc shape around the central axis O and recessed toward the other side in the radial direction are alternately arranged along the axial direction X. In a case where the exterior body 10 is in a linear state, the intervals between the crest portions 12 and the valley portions 13 adjacent to each other among the plurality of crest portions 12 and the plurality of valley portions 13 illustrated in FIG. 3 are the same interval L.

The opening 11 is formed in the exterior body 10, and is formed to extend from one end to the other end of the exterior body 10 along the axial direction X. The wiring material bundle WT is accommodated in the exterior body 10 via the opening 11.

The filling member 2 fixes the exterior member 1 to the wiring material bundle WT in an accommodated state in which the wiring material bundle WT is accommodated in the exterior body 10. The filling member 2 is a hot melt adhesive that is melted by heating to bond objects to each other. The filling member 2 is filled inside the opening 11 in an accommodated state in which the wiring material bundle WT is accommodated in the exterior body 10. For example, the filling member 2 is filled at intervals along the axial direction X of the exterior body 10. In the example illustrated in FIG. 1, there are three filling places where the filling member 2 is provided in the axial direction X with respect to the exterior body 10 having a certain length, but the number of the filling places is not limited thereto.

Next, a method for manufacturing the wire harness WH will be briefly described. An assembly worker creates a wiring material bundle WT in which a plurality of wiring materials W are bundled, and assembles the exterior member 1 to the wiring material bundle WT. Specifically, the assembly worker accommodates the wiring material bundle WT inside the exterior body 10 via the opening 11.

Next, the assembly worker fills the filling member 2 inside the opening 11 of the exterior body 10 in an accommodated state where the wiring material bundle WT is accommodated in the exterior body 10. For example, the assembly worker fills the filling member 2 inside the opening 11 at intervals along the axial direction X using a gun type adhesive injection device, and fixes the exterior member 1 to the wiring material bundle WT. The assembly worker applies the filling member 2 to the inside of the opening 11 at intervals along the axial direction X using a gun type adhesive injection device, and fixes the exterior member 1 to the wiring material bundle WT. In addition, the use amount of the filling member 2 can be suppressed by using a gun type adhesive injection device for each arrangement place of the filling member 2. In addition, the filling member 2 has a role as a fixing member for fixing the exterior member 1 to the wiring material bundle WT and a role as a protective material of the wiring material bundle WT, so that it is possible to protect the entire circumference as in the conventional cylindrical corrugated tube. In addition, since the filling member 2 is applied not by hand but by equipment, there is no difference in operation speed and appearance due to a difference in the skill level of the assembly worker. In addition, the application of the filling member 2 reduces the contact between the wiring material bundle WT and the exterior body 10, and it is possible to suppress the occurrence of abnormal noise due to the contact as compared with a conventional cylindrical corrugated tube.

As described above, the wire harness WH according to the present embodiment includes the wiring material bundle WT, the exterior member 1 having the exterior body 10 extending along the axial direction X and having an arc-shaped cross-sectional shape viewed from the axial direction X, and the opening 11 formed to extend from one end to the other end of the exterior body 10 along the axial direction X, and the filling member 2 filling at least a part of the inside of the opening 11 in an accommodated state where the wiring material bundle WT is accommodated in the exterior body 10.

With the above configuration, the wire harness WH uses the protective material only for the portion requiring protection as compared with the conventional cylindrical corrugated tube, so that the use amount of the protective material can be reduced, and the tape winding work and the attachment jig are unnecessary, so that the processing time can be shortened. A conventional cylindrical corrugated tube has an entire circumference protective function because of its cylindrical shape, and a protective material constituting the corrugated tube is also used for a portion that does not need to be protected, and the use amount of the protective material is large as a whole.

In addition, in the wire harness WH, it is easy to add the wiring material W to the wire harness WH as compared with the conventional cylindrical corrugated tube, it is not necessary to check a scratch on the covering portion due to the biting of the wiring material W, it is possible to maintain the same machining speed regardless of who is doing it, and there is little variation in quality. In the step of attaching the conventional cylindrical corrugated tube to the wiring material bundle WT, there is a fine work such as passing a tape through a slit provided in advance in the corrugated tube, and as a result, the processing time tends to be long. In addition, in a case where the corrugated tube to be assembled to the wiring material bundle WT becomes long, it takes time to process the tape winding performed on the corrugated tube and to pass the corrugated tube through the wiring material bundle WT, and as a result, the processing time tends to be long. In addition, in a case where mounting is performed using a mounting jig for passing the wiring material bundle WT into the corrugated tube, when the positions of the jig plate and the fork and the mounting space are small, it is difficult to use the jig, and the processing time may be extended.

In addition, the wire harness WH can easily add the wiring material W to the wire harness WH later as compared with the conventional cylindrical corrugated tube. In the conventional cylindrical corrugated tube, in a case where the wiring material W is added to the wire harness WH later, it is necessary to remove all the corrugated tube from the wiring material bundle WT, add the wiring material W, and then attach the corrugated tube again.

In addition, the wire harness WH can reduce the machining work of the exterior member by the operator as compared with the conventional cylindrical corrugated tube. When the conventional cylindrical corrugated tube is attached to the wiring material bundle WT, work of checking scratches on the covering portion of the wiring material W due to an edge generated in a slit of the corrugated tube or biting of the wiring material W occurs, or a difference occurs in operation speed and appearance depending on the proficiency level in winding the tape around the corrugated tube.

In the wire harness WH according to the present embodiment, the filling member 2 is filled at intervals along the axial direction X of the exterior body 10. As a result, the use of the filling member 2 can be suppressed to the necessary minimum as compared with the case where the wire harness WH is filled with the filling member 2 without intervals along the axial direction X of the exterior body 10, the material cost can be reduced, and the weight of the wire harness WH can be reduced.

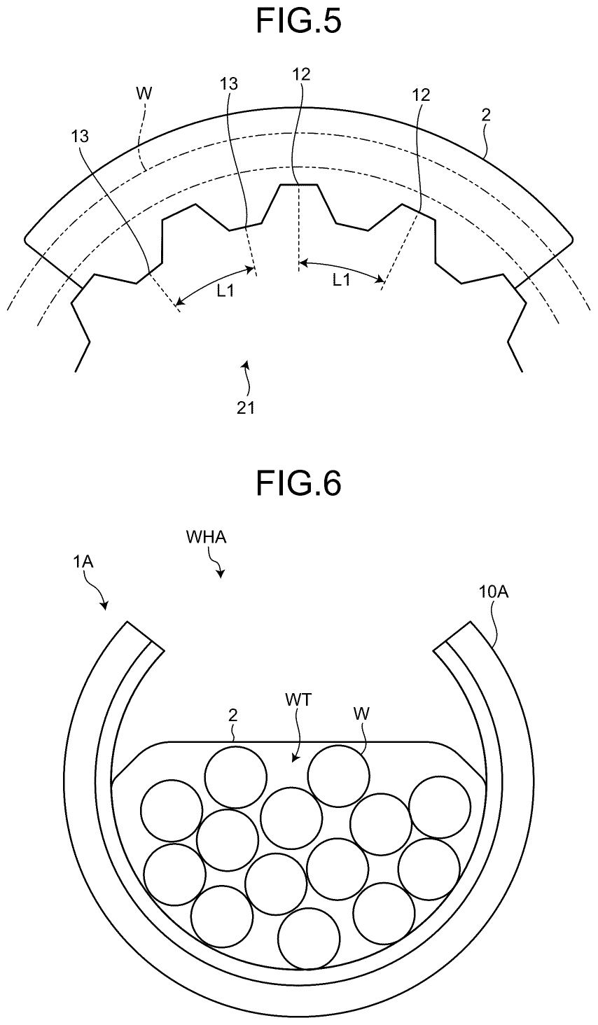

In the above embodiment, the case where the exterior body 10 is attached to the wiring material bundle WT in the straight state and fixed by the filling member 2 has been described, but the present invention is not limited thereto, and the exterior body 10 may be attached to the wiring material bundle WT in the curved state and fixed by the filling member 2. In a case where the wiring material bundle WT is brought into a curved state together with the exterior body 10 after the exterior body 10 is attached to the wiring material bundle WT, the wire harness WH has a curved portion 21 different from a linear portion 20 (see FIG. 1) in the linear state as illustrated in FIG. 4. As illustrated in FIG. 5, in the curved portion 21, the interval L between the crest portion 12 and the valley portion 13 adjacent to each other among the plurality of crest portions 12 and the plurality of valley portions 13 becomes an interval L1 different from the interval L in a case where the exterior body 10 is in the linear state. When the filling member 2 is filled in the curved portion 21 of the wire harness WH, the filling member 2 covers the adjacent crest portions 12 to fix the interval L1, and fills the adjacent valley portions 13 to fix the interval L1, so that the curved state of the curved portion 21 is maintained. That is, the exterior member 1 is maintained in a shape in which the exterior body 10 is bent in accordance with the routing path of the wiring material bundle WT in a state in which the filling member 2 is filled in the opening 11. The bent shape is the shape of the curved portion 21, and the interval L between the crest portion 12 and the valley portion 13 is widened or narrowed.

The assembly worker holds the wire harness WH in which the exterior member 1 is attached to the wiring material bundle WT in a route-regulated shape, and then fills the filling member 2 in the curved portion 21 of the wire harness WH to fix the exterior member 1 to the wiring material bundle WT.

Conventionally, when the wire harness WH is assembled to a vehicle, a clamp or the like is used to perform attachment so as to avoid an interference object with the wire harness WH. Since the wire harness WH of the present embodiment can be fixed to avoid an interference object and maintain the shape, a clamp is unnecessary for vehicle assembly, the number of installed clamps can be reduced, and as a result, the component cost can be reduced and the vehicle assemblability can be improved. In addition, the wire harness WH of the present embodiment can reduce work such as tape winding and band fixing necessary for attaching the clamp. In addition, in a case where the corrugated tube is set up to the clamp position in order to attach the clamp to the wire harness WH, since the clamp is unnecessary, it is sufficient to set the protective material only for the interference portion, and the use amount of the protective material can be reduced.

In the wire harness WH of the present embodiment, in a state where the filling member 2 is filled in the opening 11 in the curved portion 21 in the exterior member 1, the interval L1 in the curved portion 21 is fixed by the filling member 2, and the curved portion 21 is maintained in a bent shape. More specifically, in the wire harness WH, the exterior body 10 includes the curved portion 21 in which the plurality of crest portions 12 formed in an arc shape around the central axis O along the axial direction X and protruding toward one side in the radial direction intersecting the axial direction X and the plurality of valley portions 13 formed in an arc shape around the central axis O and recessed toward the other side in the radial direction are alternately arranged along the axial direction X, and has a curved shape such that the interval between the crest portion 12 and the valley portion 13 adjacent to each other among the plurality of crest portions 12 and the plurality of valley portions 13 is different from the interval L in a case where the exterior body 10 is in a linear state. In a state where the filling member 2 is filled in the opening 11 in the curved portion 21 in the exterior member 1, the interval L1 in the curved portion 21 is fixed by the filling member 2, and the curved portion 21 is maintained in a bent shape.

With the above configuration, the wire harness WH does not require a clamp or the like for maintaining the regulated path as compared with the conventional wire harness WH, and the shape of the curved portion 21 along the regulated path can be easily maintained. In addition, the wire harness WH can easily regulate the path and maintain the shape of the wiring material bundle WT and the exterior member 1, and the vehicle assemblability of the wire harness WH can be improved. In addition, by reducing the number of clamps used for the wire harness WH, the wire harness WH can reduce, for example, clamp-fixing holes provided on the vehicle body side, and reduce machining work such as tape winding for attaching the clamps. Furthermore, in the wire harness WH, the protective material set in accordance with the length of the clamp can be shortened, and the material cost can be reduced.

In the curved portion 21 illustrated in FIG. 5, as illustrated in FIG. 4, the exterior body 10 is located on the inner side of the wiring material bundle WT in the curved state, but the present invention is not limited thereto, and the exterior body 10 may be located on the outer side of the wiring material bundle WT in the curved state.

Further, the filling member 2 is filled at an interval along the axial direction X of the exterior body 10, but the present invention is not limited thereto, and the filling member 2 may be filled so as to extend from one end to the other end of the exterior body 10 along the axial direction X of the exterior body 10 and close the opening 11.

### First Modification of Embodiment

In the above embodiment, the exterior body 10 has a shape obtained by dividing a cylindrical corrugated tube in half, and a cross-sectional shape viewed from the axial direction X is formed in a semicircular shape, but the present invention is not limited thereto. For example, in a wire harness WHA illustrated in FIG. 6, the cross-sectional shape viewed from the axial direction X of an exterior body 10A is not a semicircle but a chipped circular shape. In the illustrated example, the circumferential length of the exterior body 10A is ⅔ of the entire circumference, but is not limited thereto, and is, for example, more than ½ and ⅔ or less of the entire circumference. For example, by changing the position of the slit to be added to the cylindrical slit-formed corrugated tube, the exterior body 10A can adjust the circumferential length in accordance with the thickness of the bundle diameter of the wiring material bundle WT and the position of the interference object.

In the wire harness WHA according to the first modification of the present embodiment, the cross-sectional shape viewed from the axial direction X of the exterior body 10A is formed in an arc shape, and the circumferential length of the exterior body 10A is more than ½ and ⅔ or less of the entire circumference. As a result, the wire harness WHA can adjust the circumferential length in accordance with the thickness of the bundle diameter of the wiring material bundle WT and the position of the interference object.

### Second Modification of Embodiment

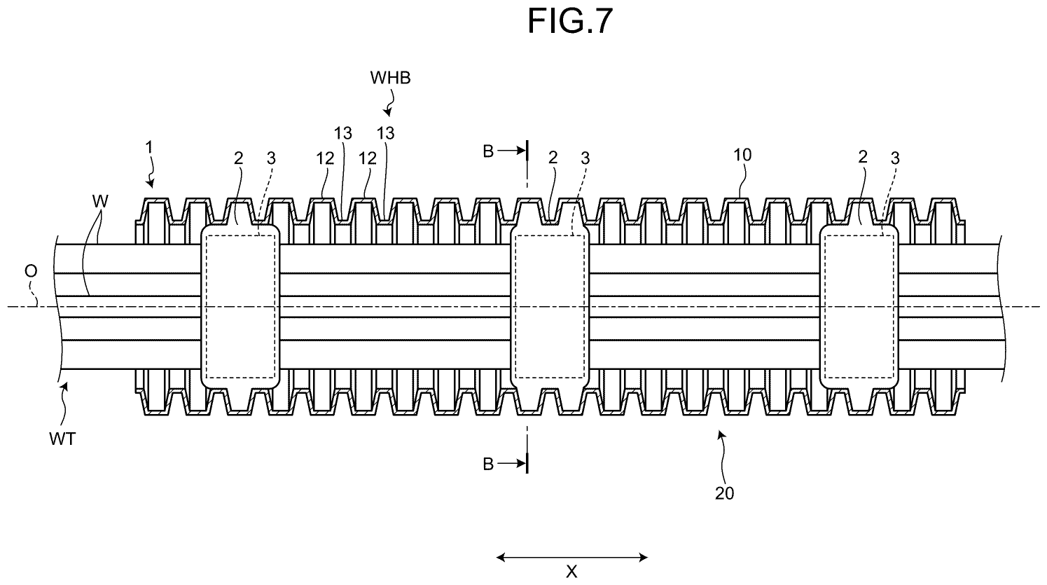

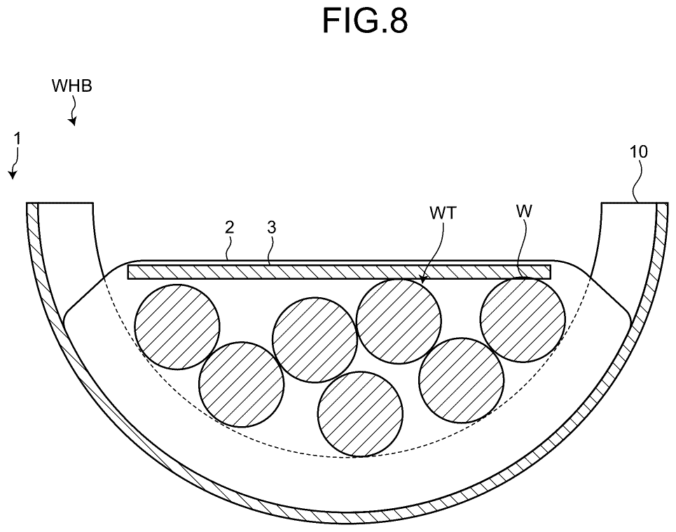

In the above embodiment, at the time of assembling the wire harness WH, the filling member 2 is filled using a gun type adhesive injection device, but the present invention is not limited thereto. For example, in a wire harness WHB illustrated in FIGS. 7 and 8, the filling member 2 has a sheet-like filling sheet 3. The filling sheet 3 is formed in a rectangular shape, and is made of, for example, a thermoplastic resin similarly to the hot melt adhesive. The filling sheet 3 is disposed at the same position as the filling position of the filling member 2. That is, the filling sheets 3 are disposed at intervals along the axial direction X of the exterior body 10.

In an accommodated state where the wiring material bundle WT is accommodated in the exterior body 10, the assembly worker arranges the plurality of filling sheets 3 inside the opening 11 of the exterior body 10 at intervals along the axial direction X. Next, the assembly worker heats each of the plurality of arranged filling sheets 3 by a gun type heating device to melt the filling sheet 3 and fix the exterior member 1 to the wiring material bundle WT. In this case, a plurality of portions required to be fixed by the filling member 2 can be simultaneously fixed by simultaneously heating each of the plurality of arranged filling sheets 3 by a gun type heating device to melt the filling sheet 3. As a result, the wire harness WHB can fix the exterior member 1 to the wiring material bundle WT without changing the processing time even when the length of the exterior member 1 in the axial direction X increases. In addition, in the wire harness WHB, since the number of attachment steps of the exterior member 1 is reduced as compared with the conventional one, it is easy to shorten the time of the attachment work and to make the attachment work active.

### Third Modification of Embodiment

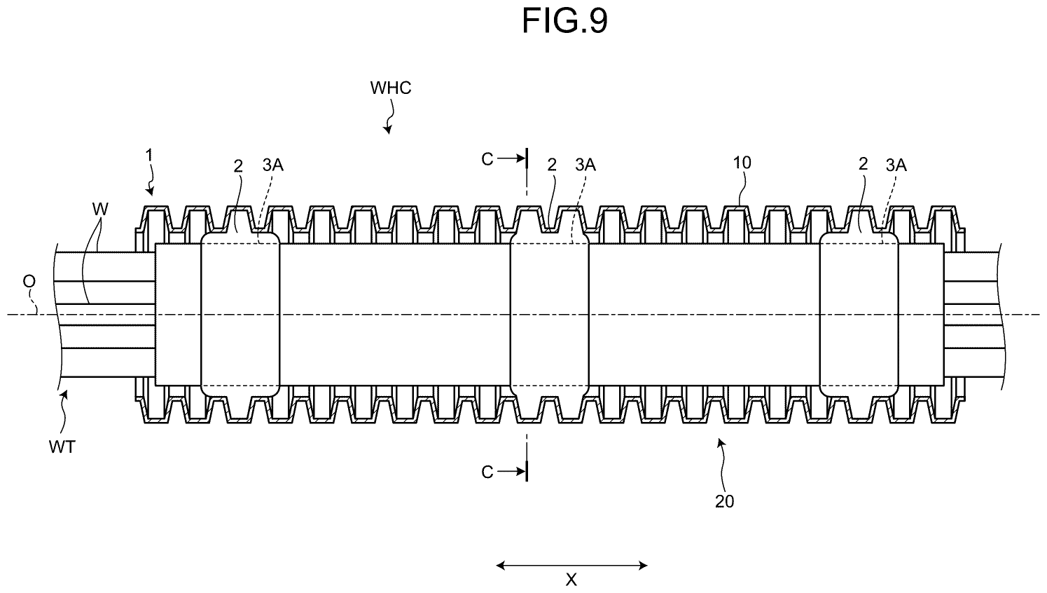

In a third modification of the above embodiment, the filling sheets 3 are disposed at intervals along the axial direction X of the exterior body 10, but the present invention is not limited thereto. For example, a wire harness WHC illustrated in FIG. 9 includes a sheet-like filling sheet 3A that connects the plurality of filling members 2. The filling sheet 3A is formed to extend from one end to the other end of the exterior body 10 along the axial direction X of the exterior body 10 and to close the opening 11. The filling sheet 3A connects the filling portions of the adjacent filling members 2 so as to cover the wiring material bundle WT exposed from the opening 11.

The assembly worker disposes the filling sheet 3A inside the opening 11 of the exterior body 10 in an accommodated state where the wiring material bundle WT is accommodated in the exterior body 10. Next, the assembly worker heats the arranged filling sheet 3A with a gun type heating device at an interval along the extending direction of the exterior body 10, and melts a part of the filling sheet 3A to fix the exterior member 1 to the wiring material bundle WT. In this case, by simultaneously heating a plurality of places of the arranged filling sheet 3A by a gun type heating device to melt the filling sheet 3, it is possible to simultaneously fix a plurality of places required to be fixed by the filling member 2. In addition, the wire harness WHC can fix the inside of the opening 11 of the exterior body 10 in a wide range by the filling sheet 3A. In addition, the wire harness WHC connects the filling portions of the adjacent filling members 2 such that the filling sheet 3A covers the wiring material bundle WT exposed from the opening 11. As a result, the wire harness WHC can suppress the wiring material bundle WT and the wiring material W from jumping out of the opening 11, and can improve the protection of the wiring material bundle WT accommodated in the exterior body 10 by the filling member 2.

According to the wire harness of the present embodiment, it is possible to reduce the machining work on the exterior member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. A wire harness comprising:
a wiring material;
an exterior member including an exterior body of which a cross-sectional shape viewed from an axial direction is formed in an arc shape and which extends along the axial direction, and an opening formed to extend from one end to an other end of the exterior body along the axial direction; and
a filling member that fills at least a part of an inner side of the opening in an accommodated state where the wiring material is accommodated in the exterior body.

2. The wire harness according to claim 1, wherein
the filling member is filled at intervals along the axial direction of the exterior body.

3. The wire harness according to claim 1, wherein
the exterior member is maintained in a shape in which the exterior body is bent in accordance with a routing path of the wiring material in a state where the filling member is filled in the opening.

4. The wire harness according to claim 2, wherein
the exterior member is maintained in a shape in which the exterior body is bent in accordance with a routing path of the wiring material in a state where the filling member is filled in the opening.

5. The wire harness according to claim 1, wherein
the exterior body includes a curved portion in which a plurality of crest portions formed in an arc shape around a central axis along the axial direction and protruding toward one side in a radial direction intersecting the axial direction and a plurality of valley portions formed in an arc shape around the central axis and recessed toward an other side in the radial direction are alternately provided along the axial direction, the curved portion having a shape bent such that an interval between crest portions adjacent to each other and an interval between valley portions adjacent to each other among the plurality of crest portions and the plurality of valley portions are respectfully different from the intervals in a case where the exterior body is in a straight state, and
the exterior member is configured such that, in a state where the opening is filled with the filling member in the curved portion, the interval in the curved portion is fixed by the filling member, and the curved portion is maintained in a curved shape.

6. The wire harness according to claim 2, wherein
the exterior body includes a curved portion in which a plurality of crest portions formed in an arc shape around a central axis along the axial direction and protruding toward one side in a radial direction intersecting the axial direction and a plurality of valley portions formed in an arc shape around the central axis and recessed toward an other side in the radial direction are alternately provided along the axial direction, the curved portion having a shape bent such that an interval between crest portions adjacent to each other and an interval between valley portions adjacent to each other among the plurality of crest portions and the plurality of valley portions is are respectfully different from the intervals in a case where the exterior body is in a straight state, and
the exterior member is configured such that, in a state where the opening is filled with the filling member in the curved portion, the interval in the curved portion is fixed by the filling member, and the curved portion is maintained in a curved shape.
